(19) United States
(12) Patent Application Publication
(10) Pub. No.: US 2009/0007744 A1
(43) Pub. Date: Jan. 8, 2009

(54) DEVICE FOR CUTTING PAPER AND OTHER GRAPHIC SUBSTRATES WOUND IN ROLLS ON TWO PERPENDICULAR AXES SIMULTANEOUSLY WITH AUTOMATIC ERRORS CORRECTION

(75) Inventor: Valter Maddalon, Pralungo (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: FOTOBA INTERNATIONAL s.r.l., Quaregna BI (IT)

(21) Appl. No.: 11/913,478

(22) PCT Filed: Mar. 29, 2006
(86) PCT No.: PCT/IT06/00198

§ 371 Date: Nov. 2, 2007

(30) Foreign Application Priority Data
May 27, 2005 (IT) MI2005A 000996

(51) Int. Cl. B26D 1/14

(52) U.S. Cl. 83/477.1

(57) ABSTRACT

A device is provided for cutting paper and other graphic substrates (10) in roll on two perpendicular axes simultaneously with automatic errors correction, both in the feeding with respect to a direction (F) along the longitudinal axis (Y) of the substrate, and of the deviation of the image with respect to the edge of the substrate itself. For this purpose, a motor (5) is provided at the horizontal cutting unit (4), in addition to a drive motor (6), suitable for shifting the cutting path in order to make it coincide with the correct cutting line (Tₓ). In the same way, for the longitudinal cutting assembly (14) along the (Y) axis, in addition to a motor (7) for performing the cut, a motor (8) is provided suitable for translating along the (X) axis the whole cutting assembly on the basis of lateral deviations detected by means of an optic cell (9), whose signals are processed by a microprocessor for the drive of the motor (8).

### CROSS-REFERENCE TO RELATED APPLICATIONS

This application is a Section 371 of International Application No. PCT/IT2006/000198, filed Mar. 29, 2006, which was published in the English language on Nov. 30, 2006, under International Publication No. WO 2006/126224 A1 and the disclosure of which is incorporated herein by reference.

### BACKGROUND OF THE INVENTION

The present invention relates to a device for the automatic finishing and cutting, on two perpendicular axes simultaneously, of paper and other graphic substrates in roll, provided with automatic correction of the errors due to skidding of the substrate, particularly for substrates printed with digital rendering systems and for large formats.

It is known that the photographic technique, including that of digital rendering, is undergoing a deep transformation and development, abandoning the printing with traditional optical systems in order to tend more and more towards ink-jet technology from digital “file” on rolls of substrates having the most varied features and dimensions. While, as to printing, remarkable speeds at a high definition have been obtained, the finishing technology of such printed substrates has been limited to developing paper cutters being able to cut along the two axes, but having great limits. In particular it was impossible to correct skidding of the roll, if badly rewound, or inaccuracies due to the image itself, if printed not perfectly parallel to the edge of the substrate. Further, it was impossible to cut along the X-axis, parallel to the image in a horizontal direction, if due to one or both the above-mentioned reasons, this side, when cut, is not perfectly at right angles with the paper cutter.

It is true that devices have been recently developed, particularly according to European patent application publications EP 0 951 973 and EP 1 268 143, both in the name of Fotoba International s.r.l., which have made it possible to automatically perform a precise cut of such substrates in a roll, however having two great limits, i.e., concerning the dimensions, a maximum format of 157 cm, and the drawback of being obliged to manually rotate the sheet by 90 degrees and reintroduce it into the paper cutter in order to obtain a perfect cut along all four sides. Given the greater and greater penetration into the market of this kind of printing, which is replacing the offset technology thanks to its flexibility and reduced costs for short runs, there has been a great increase of the processed volumes, whereby the manual finishing is no more acceptable, and it is thereby essential to automate finishing of the prints. In addition, while for small formats the consequences of possible skidding of the roll or of the image can be unimportant, in large formats these are not acceptable and their correction is made essential.

### BRIEF SUMMARY OF THE INVENTION

An object of the present invention is thus to overcome the drawbacks of the prior art for concerning the non-perfect correction of the consequences of a bad rewinding of the roll or of parallelism defects of the image with respect to the edges, making it possible to automatically cut the substrate on both the perpendicular axes simultaneously, without manual interventions.

Another important object of the present invention is that of being able to overcome the above-mentioned drawbacks and obtain the listed advantages also for formats larger than 157 cm width.

These objects are achieved with an automatic cutting device for the cutting and finishing, simultaneously on two axes X, Y perpendicular to each other, of paper and other graphic or photographic substrates with series of images marked by marks being detectable by optical sensors located near feeding rollers of the substrate, driven by a first motor, a movable cutting unit being provided suitable for cutting the substrate along the transverse direction X, perpendicular to the feed in the direction of an arrow F, along a cutting line Tₓ being adjustable by a second motor driven by possible non-alignment signals produced by the optical sensors and processed by a microprocessor, the cutting unit being driven by a third motor, further comprising a longitudinal cutting assembly for cutting the substrate along at least two cutting lines T_{Y} in a direction Y parallel to the feeding direction along arrow F. The device comprises a cutting element for each cutting line T_{Y} being provided, each of them being mounted in an adjustable position on a single axis of the cutting assembly, all the cutting elements being driven by a fourth motor, and a further fifth motor being provided for the double-directional shift along axis X of the cutting assembly in response to possible signals of non-parallelism of the image to the substrate edge, being detected by an optic cell, wherein the longitudinal cutting assembly is integral with the horizontal cutting unit.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic top plan view of an automatic cutting device according to an embodiment of the present invention during its normal operation;

FIGS. 2a and 2b are schematic top plan views of the same device of FIG. 1 during operation, respectively with correction of an oblique forward movement of the paper, schematized by the curved double arrow F′, and a correction for a transverse right-left skidding, as schematized by the double arrow F″;

FIGS. 3a and 3b are front and side views, respectively, of a preferred embodiment of the transverse movable cutting unit along the X-axis; and

FIG. 4 is an example of a substrate with printed images thereon and the respective cutting lines, as well as the longitudinal mark with double black band provided for the alignment along the Y-axis.

### DETAILED DESCRIPTION OF THE INVENTION

With reference to the drawings, the automatic cutting device according to one embodiment of the present invention comprises a pair of rollers 1 (of which only the upper roller is illustrated) for the forward movement of a web substrate 10, being fed from a roll, in the direction of arrow F, and a motor 2 for the driving thereof. In a known way, as for example from EP 0 951 973, a pair of optical sensors 3, 3′, being positioned, in particular, at two sections of reduced diameter of the rollers, detects a mark (not illustrated) provided between two subsequent images printed on substrate 10. The mark can advantageously be, although not necessarily, of the type described in the above-mentioned European patent application publication in order to allow easy determination of its angulation with respect to the cutting line Tₓ.

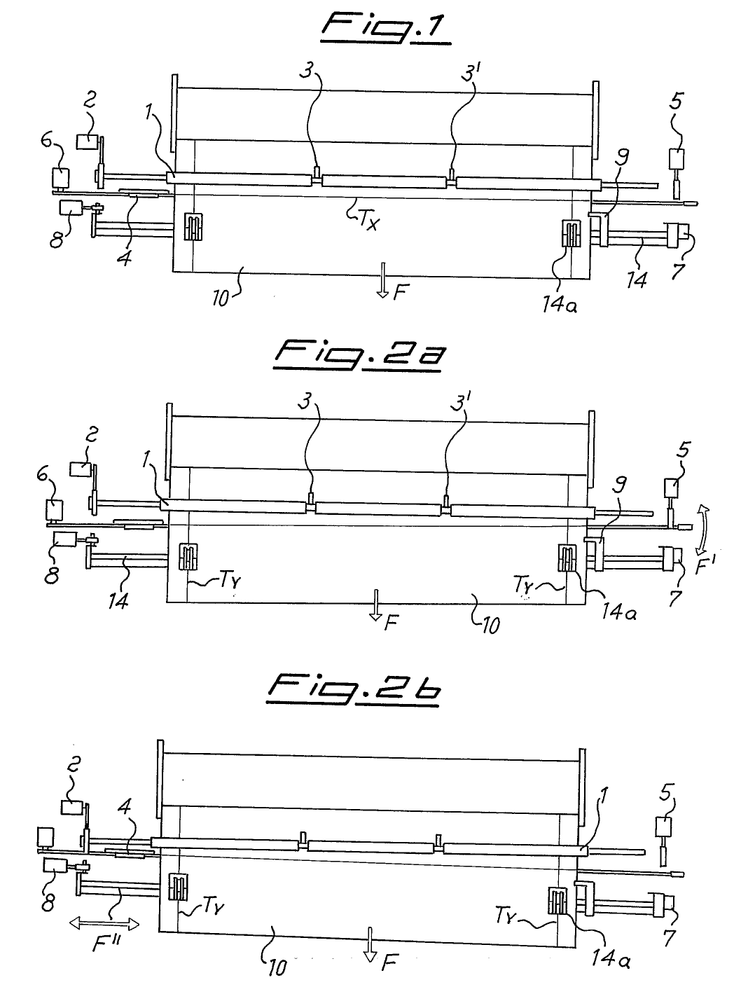

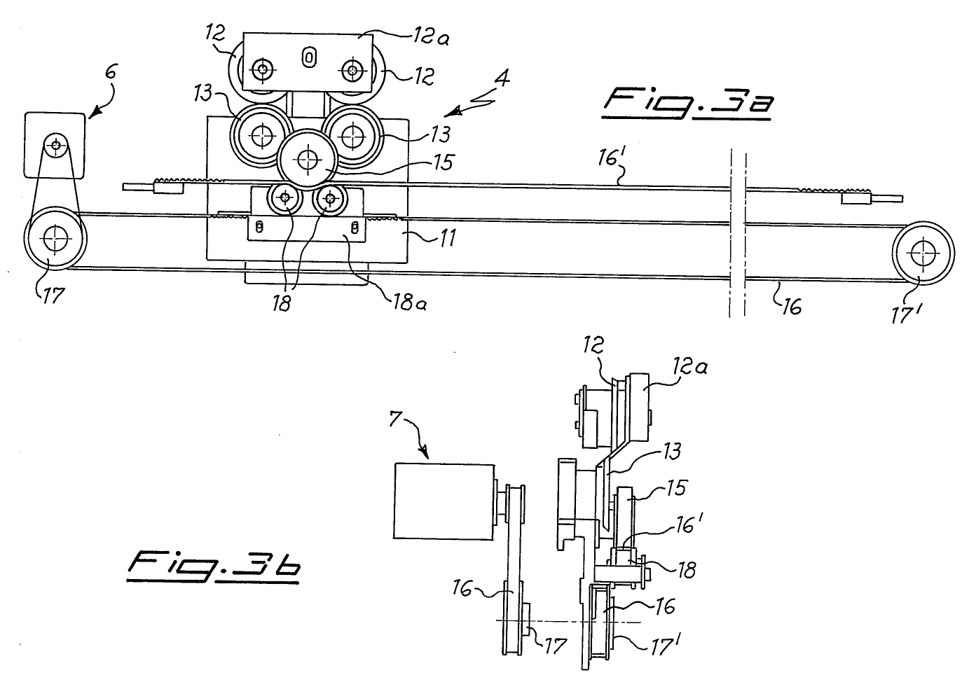

The cut is performed by a movable cutting unit 4, driven by a motor 6 and carried in alignment with the desired cutting line Tₓ, according to the deviation signal detected by optical sensors 3, 3′ and the resulting input on a motor 5 in consequence of the processing of the signal itself by a microprocessor controlling the whole system, not shown in the drawings. Driven in such a way, motor 5 determines, in a known way, an angular shift of the cutting path, e.g., for the correction of an oblique trend as in FIG. 2a. For this purpose, while one end of the sliding guides 14 of the paper cutter is movable in the double clockwise/counterclockwise direction of arrow F′, under the action of motor 5, the other end is fixed and advantageously works as a pivot for the resulting rotation.

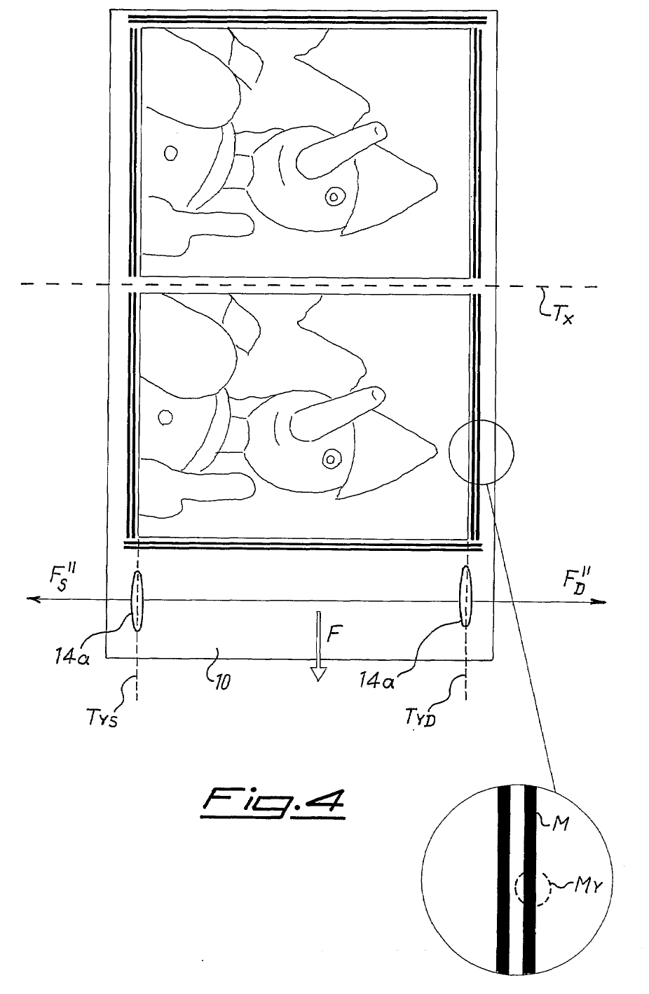

The cut is determined by the horizontal driving of the movable blade of the cutting unit 4 (along the X-axis), which can be accomplished in any known way, preferably according the embodiment that will be described more in detail with reference to FIGS. 3a and 3b.

A motor 7 is also provided for the driving of the longitudinal cutting assembly 14, with a motor 8 for its axial shifting in both directions according to arrow F″ of FIG. 2b. While the correction according to curved arrow F′ of FIG. 2a occurs in a known way, as previously by two optical sensors 3 and 3′, the transverse correction for the longitudinal cutting assembly 14 occurs, according to the present invention, simultaneously with the alignment of the cut along the X-axis, but independently from the fact that the two cutting assemblies are integral with each other. In fact, the position of the longitudinal cut T_{Y} is automatically corrected with respect to the edge of the image, by keeping its perpendicularity with respect to cutting X-axis not only in this embodiment, but also providing for the longitudinal cutting assembly being integral with the rest of the device, although being able to shift in the two directions of arrow F′.

In fact, in its preferred embodiment, the longitudinal cutting assembly 14 is formed of two or more rotating blades located above the substrate 10 to cut and finish along cutting lines T_{Y} provided for (there may be at least another cutting line at the center of substrate 10 when the images are printed in pairs in side-by-side relation along X-axis). The rotating blades 14a, being driven in any known way by motor 7, are mounted at predetermined positions, according to the dimensions of the images to be cut, on a single shaft transversally moving and driven by the motor 8.

For this purpose, with particular reference to FIG. 4, during the feed of the paper or substrate 10 a reflection optic cell 9, being assembled, e.g., on the same longitudinal cutting assembly 14 at the edge of the image, where a mark M is provided preferably with two vertical black bands and an intermediate white one, detects the positioning of the paper by measuring the reflection in a restricted area designated by M_{Y} in the drawing. Upon the image being no longer parallel to the paper edge, the sensor detects the change of state thereof and sends a directional signal to the system microprocessor for the suitable driving of the motor 8. It is preferred to use an optic cell with two different elements, one white-responsive and one black-responsive, in order to detect percentage variations of the two colors, indicia of the prevalence of one or the other black band or of the intermediate white band. In such a way, by crossing the related data still through the microprocessor processing, the input suitable for obtaining the necessary correction will be determined, by driving motor 8 for a rightward (F″_{R}) or a leftward (F″_{L}) shift of the cutting assembly 14, whereby all the rotating blades elements 14a consequently determine the corresponding cutting lines T_{YR} and T_{YL} bringing them back to the respective correct positions.

In FIGS. 3a and 3b a preferred embodiment of the transverse cutting unit 4 is shown, which provides for two pairs of blade and counter blade 12, 13 mounted in close positions, in the X-axis direction perpendicularly to the feed direction F, onto a block 11 with an appendix 12a supporting the upper blades 12. The lower or counter blades 13 are driven by a cogged pulley suitable for moving while rotating along, e.g., a cogged belt 16′ fixed to the ends, with the help of two idle pulleys 18 being present underneath, whose support 18a is integral with a ring belt 16 tense between two end pulleys 17 and 17′, one of which is driven by the motor 6. It is noted that, of course, the system of pulleys and belts 14, 15, 16 could be replaced by an equivalent anti-backlash drive system. The cogged belt 16′, along which the paper cutter holder block 11 slides, is the guide of the cutting assembly 14, being able to move at one end and pivoting at the opposite one, as previously stated.

Possible modifications can be made by those skilled in the art to the above-described and illustrated embodiment of the automatic cutting device according to the present invention, without going out of the scope of the same invention. Particularly, the optic cell 9 may not be integral with the longitudinal cutting assembly 14, although accomplishing the same functions with suitable expedients being within the abilities of one skilled in the art, and further the transverse cutting unit 4 can be differently accomplished from what is shown in FIGS. 3a and 3b, according to constructional ways known in the field.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-6. (canceled)

7. An automatic device for the cutting and finishing, simultaneously on two axes (X, Y) perpendicular to each other, of paper and other graphic or photographic substrates (10) with series of images marked by marks being detectable by optical sensors (3, 3′) located near feeding rollers (1) of the substrate (10), driven by a first motor (2), a movable cutting unit (4) being provided for being suitable for cutting the substrate (10) along the transverse direction (X), perpendicular to the feed in a direction of an arrow (F), along a cutting line (Tₓ) being adjustable by a second motor (5) driven by possible non-alignment signals produced by the optical sensors (3, 3′) and processed by a microprocessor, the cutting unit (4) being driven by a third motor (6), further comprising a longitudinal cutting assembly (14) for cutting the substrate (10) along at least two cutting lines (T_{Y}) in a direction (Y) parallel to the feeding direction along arrow (F), a cutting element (14a) for each cutting line (T_{Y}) being provided, each of them being mounted in adjustable position on a single axis of the cutting assembly (14), all the cutting elements (14a) being driven by a fourth motor (7), and a further fifth motor (8) being provided for double-directional shift along axis (X) of the cutting assembly (14) in response to possible signals of non-parallelism of the image to the substrate edge, being detected by an optic cell (9), wherein the longitudinal cutting assembly (14) is integral with the horizontal cutting unit (4).

8. The device according to claim 7, wherein the optic cell (9) is integral with the cutting assembly (14).

9. The device according to claim 7, wherein the optic cell (9) is of the reflection type and at the margin of the image to be cut a longitudinal mark (M) is provided comprising alternated white and black bands.

10. The device according to claim 8, wherein the optic cell (9) is of the reflection type and at the margin of the image to be cut a longitudinal mark (M) is provided comprising alternated white and black bands.

11. The device according to claim 9, wherein the optic cell (9) is formed of two components intended to detect possible deviations from a correct percentage value, respectively of white and black area of the mark (M), being detected in order to transmit such deviation signals to a microprocessor suitable for driving the motor (8) for the axial shifting of the whole cutting assembly (14) and thereby of the elements (14a) according to a double-arrow (F″) in direction (X).

12. The device according to claim 10, wherein the optic cell (9) is formed of two components intended to detect possible deviations from a correct percentage value, respectively of white and black area of the mark (M), being detected in order to transmit such deviation signals to a microprocessor suitable for driving the motor (8) for the axial shifting of the whole cutting assembly (14) and thereby of the elements (14a) according to a double-arrow (F″) in direction (X).

13. The device according to claim 7, wherein the transverse cutting unit (4) comprises pairs of rotating blades and counter blades (12, 13) mounted on a sliding block (11) in perpendicular direction to the forward direction arrow (F), along a path having one fixed end and the other end, being subject to the action of the second motor (5), being able to perform small clockwise and counterclockwise rotations according to a double-arrow (F′) in order to grant the alignment of the same path with the desired cutting line (T_{X}) also as a consequence of random deviations of the feeding of substrate (10) from the direction of the arrow (F).

14. The device according to claim 13, wherein the block (11) carrying the two pairs of blades and counter blades (12, 13) slides by a transmission system (16, 17, 18, 18a) by the third motor (6) drive along a guide (16′) accomplishing the path being fixed at one end and movable at the other end upon drive of the second motor (5).
